(19) United States
(12) Patent Application Publication
(10) Pub. No.: US 2021/0138738 A1
(43) Pub. Date: May 13, 2021

(54) ALTERNATIVE JOINING METHOD

(71) Applicant: SGL CARBON SE, Wiesbaden (DE)

(72) Inventor: Niclas WIEGAND, Meitingen (DE)

(73) Assignee: SGL CARBON SE, Wiesbaden (DE)

(21) Appl. No.: 16/621,803

(22) PCT Filed: Aug. 23, 2018
(86) PCT No.: PCT/EP2018/072716

§ 371 Date: Dec. 12, 2019

(30) Foreign Application Priority Data
Aug. 23, 2017 (DE) 10 2017 214 778.4

(51) Int. Cl. B29C 65/08; B29C 65/64; B29C 65/00

(52) U.S. Cl. CPC B29C 65/08; B29C 65/645; B29C 66/30321; B29C 66/712; B29C 66/7212; B29L 2031/16; B29C 66/73521; B29C 66/7394; B29C 66/74611; B29C 66/929; B29C 66/949; B29C 66/73161

(57) ABSTRACT

The disclosure relates to an alternative joining method and to the use of the shaped part produced by means of the alternative joining method in drive technology and connection technology.

The invention relates to an alternative joining method and to the use of the moulded part produced by means of the alternative joining method in drive technology and joining technology.

It is known to provide moulded parts, for example friction linings and carrier material, with an adhesive, for example a reactive resin, and to then connect said parts by means of pressure and temperature, the moulded parts being interconnected by means of the crosslinking reaction (DE102011018286A1).

The disadvantage of this is that the adhesive makes handling more difficult and the process is time-consuming as a result of the hardening reaction at an increased temperature (>150° C.). In addition, adhesives also involve safety risks.

The object of the present invention is to therefore provide an alternative joining method.

The object is achieved by a method for joining moulded parts, at least one first moulded part being a thermoplastic and at least one second moulded part being a thermoset or a ceramic, and the second moulded part comprising a structured surface, said method being characterised by the following steps:
a) providing the first and the second moulded part in an alternating sequence in a stack, and
b) applying a surface pressure and making a sonotrode create ultrasonic vibrations or making the sonotrode create ultrasonic vibrations and applying a surface pressure.

By means of the method, the moulded parts are interconnected without the need for an adhesive. Within the context of this invention, an adhesive is understood to mean a material that can connect parts to be joined by means of joining adhesion and internal strength (DIN EN 923). Within the context of this invention, the structured surface is understood to mean a surface that has a suitable surface structure (for example roughness or macroscopic structures such as pyramids (see FIG. 1)). The roughness is specified according to VDI 3400 12-45. The second moulded part comprises frictional properties resulting from the structuring process and the material selection.

By means of a sonotrode, which presses on both joining partners (first and second moulded part) by means of a surface pressure, the boundary surfaces between the joining partners heat up as a result of the vibration.

The energy is focussed by the structured surface of the second moulded part, which leads to a targeted increase in the temperature of the first moulded part. As a result of the increase in temperature, the damping coefficient of the first moulded part (the thermoplastic) increases, which leads to more internal friction and is therefore associated with a quicker rise in temperature. When the melting temperature of the first moulded part (thermoplastic) is exceeded, a melt flow forms in the structured surface of the second moulded part, which leads to the two parts to be joined digging into one another. After the melt has been cooled and solidified, the two parts are interlockingly welded together. By suitably selecting the process parameters, the frictional properties of the functional surface are not adversely affected.

The thermoset is advantageously selected from the group of phenol formaldehyde resins, thermosetting polyurethanes, epoxides, thermosetting polyesters, vinyl esters and any mixtures of two or more of said thermosets, preferably phenol formaldehyde resins or epoxides, particularly preferably phenol formaldehyde resins.

The ceramic is advantageously selected from the group of silicon carbides or carbons.

The structured surface of the second moulded part preferably has a roughness of Ra: 1-100 μm, Rk: 4-150 μm, Rpk: 1-50 μm and Rz: 20-300 μm. Ra is the arithmetic mean, Rk is the core roughness depth, Rpk is the reduced peak height, which means a mean height of the peaks protruding from the core roughness profile, and Rz is the mean roughness depth. The roughness is measured by means of a contact stylus surface texture measuring method according to DIN EN ISO 4287:2010.

If the roughness is too low, i.e. if Ra<1 μm, Rk<4 μm, Rpk<1 μm and Rz<20 μm, the energy input by means of ultrasonic sound is not focussed. As a result, the first moulded part is not softened and therefore cannot be pushed into the structure of the second moulded part, which in turn means that insufficient adhesion is produced. Furthermore, the second moulded part is destroyed during the ultrasonic treatment, which is an irreversible process. Another consequence is that there are no longer any defined frictional properties as a result of the destroyed surface.

If the roughness is too high, i.e. if Ra>100 μm, Rk>150 μm, Rpk>50 μm and Rz>300 μm, the moulded parts no longer fit together and only insufficient adhesion is achieved.

The first moulded part advantageously has a thickness of <25 mm. For a thickness of more than 25 mm, the ultrasonic sound does not penetrate said moulded part to a sufficient extent.

The second moulded part advantageously has a thickness of 0.1-2.5 mm, preferably 0.2-1.5 mm, particularly preferably 0.3-1 mm.

A thickness of less than 0.1 mm makes it more difficult to handle the moulded parts and to set the roughness.

The surface pressure in step b) is advantageously applied by the sonotrode or an abutment.

The surface pressure is advantageously in the range of 6-60 bar, preferably 10-50 bar particularly preferably 40-50 bar.

A surface pressure of <6 bar does not produce sufficient adhesion.

At a surface force of >60 bar, two effects can occur. On the one hand, the friction lining is destroyed and, on the other hand, the friction lining penetrates too deeply and inhomogeneously into the first component.

The ultrasonic vibrations in step c) advantageously last for 0.05-3 s, preferably 0.2-0.6 s, particularly preferably 0.3-0.4 s.

If the ultrasonic vibrations last for <0.05 s, the first component does not soften or melt. The effect according to the invention of an adhesive-free adhesion therefore does not occur. If the ultrasonic vibrations last for >3 s, the process stability is no longer ensured.

According to another preferred embodiment, the second moulded part is a fibre-reinforced thermoset or a fibre-reinforced ceramic.

Within the context of the invention, the fibre-reinforced thermoset has a degree of cros slinking of between 40 and 100%, preferably between 60 and 80%.

In this case, the surface is structured by suitably selecting the fibre volume content, which is described by the fibre to matrix ratio, the mould pressure during consolidation and the textile architecture.

Within the context of the invention, the textile architecture is understood to mean a plain weave and/or twill weave, wherein a yarn having a yarn count of tex 50-200 is used as the warp and weft thread. The warp and weft density is in the range of 7-18/cm.

The fibre volume ratio is advantageously 35-55%, preferably 40-48%, particularly preferably 44-46%.

The fibre reinforcement is advantageously selected from the group of carbon fibres, glass fibres, aramid fibres, highly crosslinked polymer fibres, cellulose fibres, basalt fibres or mixtures thereof, preferably carbon fibres.

The moulded part produced according to the invention can be used as a friction element in drive technology and joining technology.

The operating temperature is advantageously between −20 and 140° C., preferably 10-50° C., particularly preferably 15-25° C. In this case, across the operating range, the temperature may not be above the melting point of the first moulded part; at too low temperatures, i.e. below the operating temperature, delamination caused by the cold brittleness of the joined component occurs.

In the following, the present invention will be described purely by way of example on the basis of advantageous embodiments and with reference to the attached drawings. The invention is not restricted by the drawings, in which:

FIG. 1 shows different macroscopic structures of the surface in cross section;

FIG. 2 shows the setup of the alternative joining method in cross section;

FIG. 3 shows a detail of the setup of the alternative joining method in cross section;

FIG. 4 shows the process of joining the moulded parts (1, 2) in cross section; and

FIG. 5 is a schematic view of the roughness of a structured surface.

FIG. 1 shows different possible macroscopic structures in cross section, such as semi-ellipses, semicircles, acute triangles or equilateral triangles. Within the context of the invention, combinations of these macroscopic structures are also possible.

FIG. 2 shows the moulded parts (1, 2) inserted into the holder (4) and the sonotrode (3) arranged thereabove in cross section.

FIG. 3 shows a detail of the moulded parts (1, 2) inserted into the holder (4) and the sonotrode (3) arranged thereabove in cross section. The moulded part (2) comprises a structured surface (5).

FIG. 4 is a cross section showing that, by means of the sonotrode (3) that is made to create ultrasonic vibrations, the softened first moulded part (1) is pressed into the structured surface of the second moulded part (2) by the surface force applied.

Once the ultrasonic treatment has finished, the softened moulded part (1) immediately solidifies so that the joined component can be removed immediately.

FIG. 5 is a schematic view of the roughness of a structured surface, as can be measured by means of a profilometer. The roughness can be stochastically distributed over the surface.

In the following, the present invention will be explained on the basis of an embodiment, the embodiment in no way restricting the invention.

### EMBODIMENT

A first moulded part having the dimensions (internal diameter: 20 mm, external diameter: 27 mm, thickness: 2.2 mm) and a second moulded part having the dimensions (internal diameter: 21 mm, external diameter: 26 mm, thickness: 0.4 mm) are provided in a stack beneath the sonotrode, the second moulded part being arranged beneath the first moulded part. The first moulded part consists of polyamide 6.6. The second moulded part consists of carbon fibre-reinforced phenolic resin. The sonotrode is moved towards the stacked moulded parts at a defined surface pressure of 40 bar and is then made to create ultrasonic vibrations having a frequency of 30 kHz for 0.2 s. The sonotrode is then moved away from the moulded parts and the joined moulded parts can be removed.

Both the frictional properties and adhesive properties are identical to those of a glued product, but it was possible to improve the process time by 30 decades.

### LIST OF REFERENCE NUMERALS

1 first moulded part
2 second moulded part
3 sonotrode
4 holder
5 structured surface of the second moulded part

1-14. (canceled)

15. A method for joining moulded parts, at least one first moulded part being a thermoplastic and at least one second moulded part being a thermoset or a ceramic, and the second moulded part comprising a structured surface, said method comprising the following steps:
a) providing the first and the second moulded part in an alternating sequence in a stack, and
b) applying a surface pressure and making a sonotrode create ultrasonic vibrations or making the sonotrode create ultrasonic vibrations and applying a surface pressure.

16. The method according to claim 15, wherein the thermoset is selected from the group consisting of phenol formaldehyde resins, thermosetting polyurethanes, epoxides, thermosetting polyesters, vinyl esters and any mixtures of two or more of said thermosets.

17. The method according to claim 15, wherein the ceramic is selected from the group of silicon carbides or carbons.

18. The method according to claim 15, wherein the structured surface of the second moulded part has a roughness of Ra: 1-100 μm, Rk: 4-150 μm, Rpk: 1-50 μm and Rz: 20-300 μm.

19. The method according to claim 15, wherein the first moulded part has a thickness of <25 mm.

20. The method according to claim 15, wherein the second moulded part has a thickness of from 0.1-2.5 mm.

21. The method according to claim 15, wherein the surface pressure in step b) is applied by the sonotrode or an abutment.

22. The method according to claim 15, wherein the surface pressure is in the range of 6-60 bar.

23. The method according to claim 15, wherein the ultrasonic vibrations in step c) last for 0.05-3 s.

24. The method according to claim 15, wherein the second moulded part is a fibre-reinforced thermoset or a fibre-reinforced ceramic.

25. The method according to claim 24, wherein the fibre volume ratio is 35-55%.

26. The method according to claim 24, wherein the fibre reinforcement is selected from the group of carbon fibres, glass fibres, aramid fibres, highly crosslinked polymer fibres, cellulose fibres, basalt fibres or mixtures thereof.

27. A use of a moulded part produced as per a method according to claim 15 as a friction element in drive technology and joining technology.

28. The Use of a moulded part according to claim 27, wherein the operating temperature is between −20 and 140° C.
